(19) United States
(12) Patent Application Publication
(10) Pub. No.: US 2010/0295786 A1
(43) Pub. Date: Nov. 25, 2010

(54) INPUT DEVICE

(75) Inventors: Yun Ai, JiangSu (CN); Chia-Huang Chan, Taipei (TW); Yi Liu, JiangSu (CN); Ping-Yi Meng, JiangSu (CN); Zhe-Shun Zhong, JiangSu (CN); Xiao-Min Liu, JiangSu (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: MAINTEK COMPUTER (SUZHOU) CO., LTD., JiangSu (CN); PEGATRON CORPORATION, Taipei (TW)

(21) Appl. No.: 12/749,675

(22) Filed: Mar. 30, 2010

(30) Foreign Application Priority Data
May 20, 2009 (TW) 98116706

(51) Int. Cl. G09G 5/08

(52) U.S. Cl. 345/163

(57) ABSTRACT

This invention provides an input device. The input device includes a first casing, a second casing, a button unit, and an expansion part. The second casing is pivotally connected to the first casing. The button unit is connected to the first casing. The expansion part is disposed at the first casing and the second casing. When the input device is in a using state, the first casing and the second casing are coplanar. When the input device is in a storage state, the second casing covers the first casing and the expansion part is compressed.

### CROSS-REFERENCE TO RELATED APPLICATIONS

This Non-provisional application claims priority under 35 U.S.C. §119(a) on Patent Application No(s). 098116706 filed in Taiwan, Republic of China May 20, 2009, the entire contents of which are hereby incorporated by reference.

### BACKGROUND OF THE INVENTION

1. Field of the Invention

This invention relates to an input device and, more particularly, to an input device having both a foldable structure and a compressible structure.

2. Description of the Related Art

Nowadays, notebook computers have become more and more popular because of portability. Since a mouse as an input device of the notebook computer is usually in contact with a hand of a user, whether the designed structure thereof is comfortable is important for the user.

FIG. 1 is a schematic diagram showing a conventional mouse. According to ergonomics, the structure of a mouse 1 is designed to be curved. However, because of the curved structure, the mouse 1 has a great volume and occupies a great space in a briefcase when the user carries the mouse. Thus, the portability of the notebook computer is deteriorated.

### BRIEF SUMMARY OF THE INVENTION

This invention provides an input device to improve the prior art.

This invention provides an input device. The input device includes a first casing, a second casing, a button unit, and an expansion part. The second casing is pivotally connected to the first casing. The button unit is connected to the first casing. The expansion part is disposed at the first casing and the second casing. When the input device is in a using state, the first casing and the second casing are coplanar. When the input device is in a storage state, the second casing covers the first casing and the expansion part is compressed.

According to the invention, the structure of the input device is foldable and compressible. The input device can be rotated to fold for storage thus to reduce the volume occupied by the input device. Further, when the input device is in use, the contacting area between a hand of a user and the input device increases via the expansion part. Besides having convenience in carrying and storing, the input device also has advantages of strengthening control, improving comfort, and reducing tiredness.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional mouse;

FIG. 2 is an exploded diagram showing an input device according to a first embodiment of the invention;

FIG. 3 is a schematic diagram showing the input device in a using state according to the first embodiment of the invention;

FIG. 4A is an operation schematic diagram showing the input device in storing according to the first embodiment of the invention;

FIG. 4B is a schematic diagram showing the input device in a storage state according to the first embodiment of the invention;

FIG. 5 is an exploded diagram showing an input device according to a second embodiment of the invention;

FIG. 6A is a schematic diagram showing the input device in a using state according to the second embodiment of the invention; and

FIG. 6B is a schematic diagram showing the input device in a storage state according to the second embodiment of the invention.

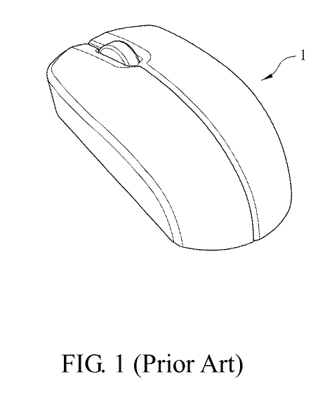

### DETAILED DESCRIPTION OF THE INVENTION

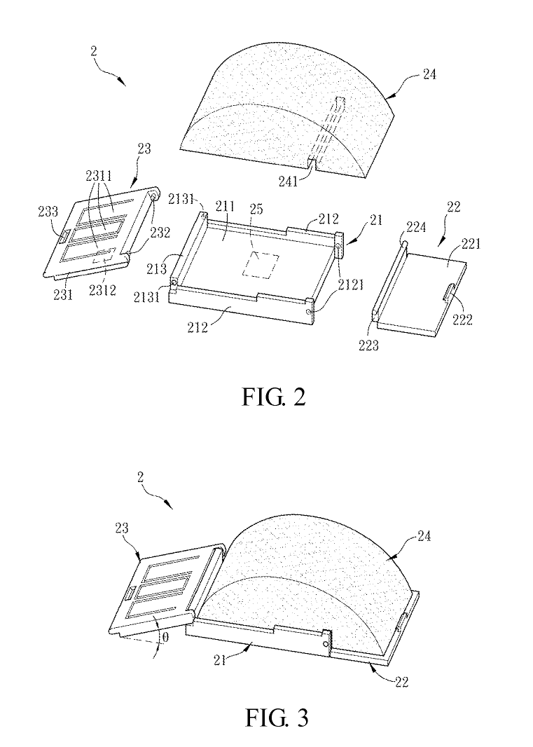

FIG. 2 is an exploded diagram showing an input device according to a first embodiment of the invention. An input device 2 according to the embodiment includes a first casing 21, a second casing 22, a button unit 23, an expansion part 24, and a control unit 25. In the embodiment, the input device 2 is a mouse. However, the invention is not limited thereto.

In the embodiment, the second casing 22 and the button unit 23 can be pivotally connected to the first casing 21 at two sides, respectively. The expansion part 24 is disposed at the first casing 21 and the second casing 22. The control unit 25 is disposed in the first casing 21. However, the invention is not limited thereto.

In the embodiment, the first casing 21 has a first main body 211, two first side walls 212, and a second side wall 213. The two first side walls 212 and the second side wall 213 are connected to the first main body 211 at outer sides, respectively.

In the embodiment, the two first side walls 212 are disposed at opposite sides of the first main body 211, respectively. The second side wall 213 is connected with the two first side walls 212. The two first side walls 212 and the second side wall 213 form an open containing space for containing a portion of the expansion part 24. The two first side walls 212 have a first through hole 2121 at the end away from the second side wall 213, respectively. The two ends of the second side wall 213 have a second through hole 2131, respectively. However, the invention is not limited thereto.

In the embodiment, the second casing 22 has a second main body 221, a first connecting portion 222, a third side wall 223, and a first shaft 224. The first connecting portion 222 and the third side wall 223 are connected to the second main body 221 at opposite sides, respectively. The first shaft 224 is disposed at the third side wall 223. The second casing 22 is pivotally connected to the first casing 21 via cooperation of the first shaft 224 and the first through holes 2121. The first connecting portion 222 can be a hook. However, the invention is not limited thereto.

In the embodiment, the button unit 23 has a third main body 231, two second shafts 232, and a second connecting portion 233.

In the embodiment, the third main body 231 includes a plurality of buttons 2311 and an input control circuit 2312. The buttons 2311 are a left button, a scroll button, and a right button. The scroll button can be a touch button disposed between the left button and the right button. The input control circuit 2312 is electrically connected with the buttons 2311. The input control circuit 2312 detects operation of the buttons 2311, thus to generate different input signals. The number, position, and type of the buttons 2311 are not limited in the invention. In other embodiments, the scroll button may further be a scroll wheel.

In the embodiment, the two second shafts 232 are disposed at opposite sides of the third main body 231 respectively and protrude from the third main body 231. The button unit 23 can be pivotally connected to the first casing 21 via cooperation of the second shafts 232 and the second through holes 2131. However, the invention is not limited thereto.

In the embodiment, the second connecting portion 233 is disposed at one side of the third main body 231 corresponding to the first connecting portion 222. The second connecting portion 233 can be a slot. When the button unit 23 and the second casing 22 are rotated to a certain position, respectively, the second connecting portion 233 can be connected with the first connecting portion 222 via engagement. However, the invention is not limited thereto. In other embodiments, the second connecting portion 233 may be a magnet, and the first connecting portion 222 may correspondingly be a metal sheet. The second connecting portion 233 may be connected with the first connecting portion 222 via magnetic attraction. Otherwise, the second connecting portion 233 may be connected with the first connecting portion 222 via Velcro.

In the embodiment, the expansion part 24 has a groove 241. The groove 241 can be disposed at the bottom of the expansion part 24 for containing the third side wall 223 and the first shaft 224. Thus, the expansion part 24 can be positioned exactly.

In the embodiment, the expansion part 24 is positioned by the groove 241 thus to be disposed on the first casing 21 and the second casing 22. However, the invention is not limited thereto. In other embodiments, the expansion part 24 may also be disposed on the first casing 21 and the second casing 22 by adhering, and thus the groove 241 is not needed.

In the embodiment, the expansion part 24 can be made of a sponge. The expansion part 24 can be compressed freely by external force. After the external force disappears, the expansion part 24 is restored to a normal state. In the embodiment, the upper surface of the expansion part 24 can be curved. However, the material, shape, and number of the expansion part 24 are not limited in the invention. The expansion part 24 can be made of any material capable of being compressed and expanding freely. The expansion part 24 can also be in any shape satisfying ergonomics. In the embodiment, the expansion part 24 is an integral. In other embodiments, the expansion part 24 may be formed by two individual parts. One part is disposed on the first casing 21, and the other part is disposed on the second casing 22.

In the embodiment, the control unit 25 is electrically connected with the button unit 23. The control unit 25 can include a light emitting element, a photoelectric detecting element, an image analyzing chip and so on. The control unit 25 receives an input signal generated by the input control circuit 2312, thus to generate a corresponding control signal. The control unit 25 can further generate a corresponding displacement signal according to the position change of the input device 2. However, the invention is not limited thereto.

FIG. 3 is a schematic diagram showing the input device 2 in a using state according to the first embodiment of the invention. In the embodiment, when the input device 2 is in the using state, the first casing 21 and the second casing 22 are coplanar. The expansion part 24 is in the normal state. The button unit 23 and the first casing 21 form an angle θ for facilitating operation by a user.

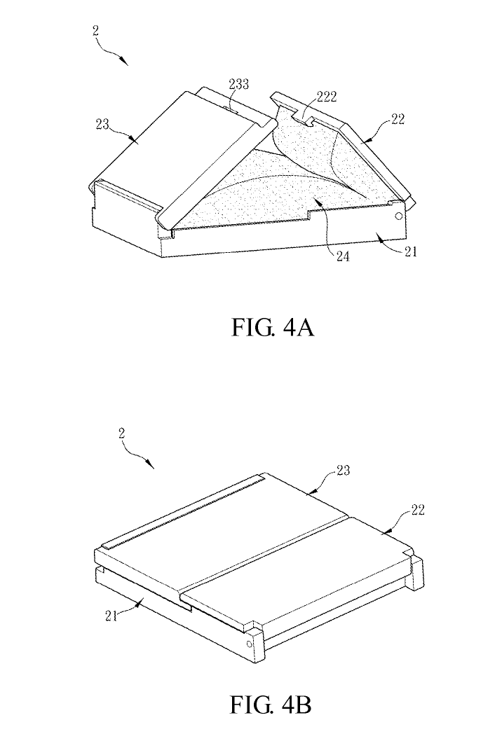

FIG. 4A is an operation schematic diagram showing the input device 2 in storing according to the first embodiment of the invention. FIG. 4B is a schematic diagram showing the input device 2 in a storage state according to the first embodiment of the invention. Please refer to FIG. 4A and FIG. 4B together.

In the embodiment, when the input device 2 is stored, the second casing 22 and the button unit 23 are rotated toward the first casing 21, respectively. After contacting the expansion part 24 disposed on the first casing 21, the second casing 22 and the button unit 23 are continually rotated to compress the expansion part 24 gradually until the second casing 22 and the button unit 23 cover the first casing 21 in parallel. At that moment, the first connecting portion 222 can be engaged with the second connecting portion 233, such that the button unit 23 and the second casing 22 are coplanar, and the input device 2 becomes flat.

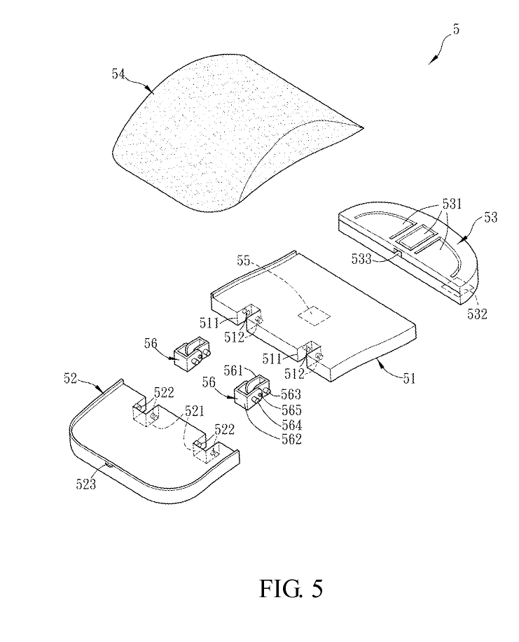

FIG. 5 is an exploded diagram showing an input device according to a second embodiment of the invention. An input device 5 according to the embodiment includes a first casing 51, a second casing 52, a button unit 53, an expansion part 54, a control unit 55, and two pivotal connecting parts 56. In the embodiment, the input device 5 is a mouse, and the number of the pivotal connecting parts 56 is two. However, the invention is not limited thereto.

In the embodiment, the second casing 52 is pivotally connected to the first casing 51 at one side via the pivotal connecting parts 56. The button unit 53 is connected to the first casing 51 and is disposed at another side opposite to the second casing 52. The expansion part 54 is disposed on the first casing 51 and the second casing 52. The control unit 55 is disposed in the first casing 51. However, the invention is not limited thereto.

In the embodiment, the first casing 51 has two first openings 511 and two pairs of first shaft holes 512. The two first openings 511 are disposed at one side of the first casing 51 facing the second casing 52. The two pairs of first shaft holes 512 are disposed at the two first openings 511, respectively. However, the numbers of the first openings and the first shaft holes are not limited in the invention, and the numbers can correspond to that of the pivotal connecting parts 56.

In the embodiment, the second casing 52 has two second openings 521, two pairs of second shaft holes 522, and a first connecting portion 523. The second openings 521 are disposed at one side of the second casing 52 facing the first openings 511. The two pairs of the second shaft holes 522 are disposed at the two second openings 521, respectively. The numbers of the second openings 521 and the second shaft holes 522 correspond to that of the first openings 511 and the first shaft holes 512, respectively. The first connecting portion 523 is disposed at another side of the second casing 52 and faces the second openings 521. The structure of the first connecting portion 523 is the same with that described in the first embodiment. Therefore, it is not described herein for a concise purpose.

In the embodiment, the pivotal connecting part 56 has a first part 561, a second part 562, a first shaft 563, a second shaft 564, and a third shaft 565.

In the embodiment, the first part 561 is contained in the first opening 511. The second part 562 is contained in the second opening 521. The first shaft 563 is disposed through the first part 561. The two ends of the first shaft 563 are disposed in the first shaft holes 512 and can be rotated in the first shaft holes 512. The second shaft 564 is disposed through the second part 562. The two ends of the second shaft 564 are disposed in the second shaft holes 522 and can be rotated in the second shaft holes 522. The third shaft 565 is disposed through the first part 561 and the second part 562 at the same time, such that the second part 562 is pivotally connected to the first part 561. However, the invention is not limited thereto.

In the embodiment, the first part 561 has through holes (not shown). The first shaft 563 is disposed through the first part 561 via the through holes. However, the invention is not limited thereto. In other embodiments, the first part 561 and the first shaft 563 may be integrally formed. The connecting mode of the second part 562 and the second shaft 564 is also not limited in the invention.

In the embodiment, the first part 561 is pivotally connected to the second part 562 via the third shaft 565. However, the invention is not limited thereto. In other embodiments, the first part 561 and the second part 562 may be integrally formed, and the first part 561 is fixedly connected to the second part 562.

In the embodiment, the pivotal connecting parts 56 are contained in the first openings 511 and the second openings 521. Therefore, after the first casing 51 is pivotally connected with the second casing 52 via the pivotal connecting parts 56, when the input device 5 is in a using state, the upper surfaces of the first casing 51 and the second casing 52 can form a flat surface without any protrusion. Thus, the appearance is more aesthetic, and the expansion part 54 can be ensured to be flatly positioned on the first casing 51 and the second casing 52.

In the embodiment, each of the pivotal connecting parts 56 has at least two shafts and can be rotatably connected to the first casing 51 and the second casing 52, respectively. When the second casing 52 is rotated 180 degrees to cover the first casing 51 in parallel, the pivotal connecting parts 56 can also be rotated 90 degrees therewith, such that the exposed surfaces of the input device 5 are flat. The appearance is more aesthetic, and the input device 5 facilitates storage by a user.

In the embodiment, the button unit 53 includes a plurality of buttons 531, an input control circuit 532, and a second connecting portion 533. The second connecting portion 533 is disposed at one side of the button unit 53 corresponding to the first connecting portion 523. The buttons 531, the input control circuit 532, and the second connecting portion 533 are all the same with that described in the first embodiment. Therefore, they are not described herein for a concise purpose. The difference is that the button unit 53 in the embodiment does not have the second shafts described in the first embodiment, and the button unit 53 is fixedly connected to the first casing 51.

In the embodiment, the upper surface of the expansion part 54 can be curved, and the bottom surface thereof can be flat. However, the invention is not limited thereto. The material and number of the expansion part 54 are the same with that described in the first embodiment. Therefore, it is not described herein for a concise purpose.

In the embodiment, the control unit 55 is the same with that described in the first embodiment. Therefore, it is not described herein for a concise purpose.

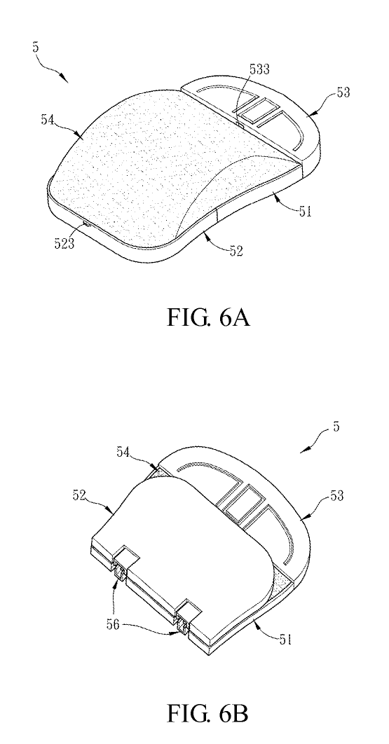

FIG. 6A is a schematic diagram showing the input device in a using state according to the second embodiment of the invention. FIG. 6B is a schematic diagram showing the input device in a storage state according to the second embodiment of the invention. Please refer to FIG. 5, FIG. 6A, and FIG. 6B together.

In the embodiment, when the input device 5 is in the using state, the first casing 51, the second casing 52, the button unit 53, and the pivotal connecting parts 56 are coplanar. The expansion part 54 is in a normal state.

In the embodiment, when the input device 5 is stored, the second casing 52 is rotated around the pivotal connecting parts 56 toward the first casing 51. After a portion of the expansion part 54 disposed on the second casing 52 contacts the other portion of the expansion part 54 disposed on the first casing 51, the second casing 52 is continually rotated to compress the expansion part 54 gradually until the second casing 52 covers the first casing 51 in parallel. At that moment, the pivotal connecting parts 56 are rotated 90 degrees relative to the position thereof in the using state, the second casing 52 is rotated 180 degrees relative to the position thereof in the using state. At the same time, the first connecting portion 523 can be engaged with the second connecting portion 533.

To sum up, the structure of the input device in the embodiment of the invention is foldable and compressible. The input device can be rotated to fold for storage, thereby reducing the volume occupied by the input device. Further, when the input device is used, the contacting area between a hand of the user and the input device increases via the expansion part. Besides having convenience in carrying and storing, the input device also has advantages of strengthening control, improving comfort, and reducing tiredness.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An input device comprising:
a first casing;
a second casing pivotally connected to the first casing;
a button unit connected to the first casing; and
an expansion part disposed at the first casing and the second casing,
wherein when the input device is in a using state, the first casing and the second casing are coplanar, and when the input device is in a storage state, the second casing covers the first casing and the expansion part is compressed.

2. The input device according to claim 1, wherein the button unit is pivotally connected to the first casing, and when the input device is in the storage state, the button unit covers the first casing and is coplanar with the second casing.

3. The input device according to claim 2, wherein when the input device is in the using state, the button unit and the first casing form an angle.

4. The input device according to claim 1, wherein the second casing has a first connecting portion, the button unit has a second connecting portion, and when the input device is in the storage state, the first connecting portion is connected with the second connecting portion.

5. The input device according to claim 1, wherein the button unit comprises a plurality of buttons and an input control circuit, and the input control circuit is electrically connected with the buttons.

6. The input device according to claim 1, further comprising a control unit disposed at the first casing and electrically connected with the button unit, the control unit used for generating a control signal.

7. The input device according to claim 1, wherein the expansion part is made of a sponge.
